(19) United States
(12) Patent Application Publication
(10) Pub. No.: US 2009/0130564 A1
(43) Pub. Date: May 21, 2009

(54) Method of fabrication electrodes with low contact resistance for batteries and double layer capacitors

(75) Inventor: Elena Shembel, Colar Springs, FL (US)

Correspondence Address: Elena Shembel, 4956 Rothschild Dr., Coral Springs, FL, 33073, US

(73) Assignee: Enerize Corporation, Coral Springs, FL (US)

(21) Appl. No.: 11/986,013

(22) Filed: Nov. 19, 2007

(51) Int. Cl. H01M 4/00; H01M 6/00

(52) U.S. Cl. 429/232; 29/623.1

(57) ABSTRACT

The present invention is a low-cost method for fabricating electrodes for batteries, electric double-layer capacitors (EDLC or supercapacitors) and hybrid electrical energy storage devices. for which by low contact resistance between the metal current collector and carbon-containing electrode enhances performance. The electrodes comprise at least two layers. The first layer is a highly conductive carbon material, such as graphite, fused into the metal current collector. The second layer is a polarizing carbon-containing electrode typically comprising a nanoporous carbon powder pressed or rolled with a binder, or a composite that includes active materials (for example oxides, sulfides), binder and conductive additives such as carbon, black. The method provides electrodes with low interface resistance, which lowers the overall internal electrical resistance of the battery or EDLC devices in which they are used and allows it to deliver increased power.

### CROSS-REFERENCE TO RELATED APPLICATIONS

This application claims priority of PCT # WO 2007/116244 A2 filed 23 Jun., 2005

### FEDERALLY SPONSORED RESEARCH

None

### SEQUENCE LISTING

None

### FIELD OF THE INVENTION

This invention relates to a method of fabricating the electrodes for batteries and double-layer capacitors (EDLC). More particularly, the invention relates to a method of fabricating electrodes for batteries and double-layer capacitors or hybrid devices with low contact (or interfacial) resistance between the electrode material and metal current collector.

### BACKGROUND

Double-layer capacitors, also referred to as electrochemical double layer capacitors (EDLC) or supercapacitors, are energy storage devices that are characterized by very low internal resistance in order to provide the high power output. One way of improving EDLC devices is to reduce all contributions to the internal resistance. These include the contact resistance between the polarizing nanoporous carbon electrode and metal current collector. Low internal impedance is also very important in battery technology such as lithium primary or secondary batteries, wherein carbon or carbon-containing polarizing electrodes have contact planes with metal current collectors. The electrodes are typically made of powdered carbonaceous materials, e.g. nanoporous carbon powder in EDLC or carbon based (e.g. graphite) powder in Li-ion batteries, or comprised of electrically conductive materials, e.g. carbon black or graphite powder in various cathode materials based on non-conducting oxides or sulfides.

A significant problem is that typically there is a very poor adhesion between carbon particles and metal foil, such as when the aluminum foil is used as a current collector. The aluminum foil can be covered with a native insulating oxide film about 5 nm thick. Poor adhesion as well as the insulating film can increase a contact (or interfacial) resistance between the electrode material and metal current collector resulting in degraded performance of these energy storage devices. What is needed is a low cost method for forming low contact resistance contact between the metal current collector and carbon-containing electrode.

### SUMMARY OF THE INVENTION

An object of the present invention is to develop a low-cost but still effective method of fabricating the electrodes for batteries, double-layer capacitors or hybrid devices with low contact resistance between the metal current collector and carbon-containing electrode. An example of hybrid device is supercapacitor/Li-ion battery. Another object of the present invention to develop a gradient electrode material, which comprises at least two different layers: the first layer is a highly conductive carbon material, e.g. graphite or pyrocarbon, fused into the metal current collector, e.g. aluminum foil, and the second layer is a polarizing carbon-containing electrode, e.g. a nanoporous carbon powder pressed or rolled with a binder as is used in EDLC technology or composite which includes active materials (for example oxides, sulfides), binder and conductive additives (for example carbon, black) as is used in battery technology.

### DESCRIPTION OF RELATED ART

U.S. Pat. No. 5,907,472 (Farahmandi et al.) discloses a method to lower the internal resistance of an EDLC by the use of aluminum-impregnated carbon cloth electrodes. However, the carbon cloth used in such electrodes tends to be somewhat costly. And as an electrode material, carbon cloth is inherently too thick (300 microns or more) to provide the very low resistivity needed. Thus, it would be advantageous to have a method and/or apparatus for lowering the internal resistance of double layer capacitors that does not rely on carbon cloth.

U.S. Pat. No. 6,447,555 (Okamura, et al.) discloses a method for reducing the contact resistance between the aluminum current collectors and their respective polarizing electrodes via the granular carbon. In accordance with the invention, hard amorphous granular carbon is made to penetrate into the surface of the aluminum collector. Granular carbon is sprayed and pressed against the surface using a roller by some other method. As a result, the hard granular carbon penetrates through the oxide film into the surface of the aluminum foil. The metal current collector should preferably have a rough surface. In particular, carbon particles should preferably project slightly from the surface of the metal material. In addition, for EDLC, a layer of nano-porous carbon with a binder (a polarizing electrode) can be fixed firmly to the roughened surface, and the contact resistance of the surface can thus be reduced by ca. 2.5 times as compared with the plain aluminum foil.

U.S. Pat. Nos. 6,493,210 and 6,808,845 to Nonaka, et al. disclose a method for producing a valve metal material for electrodes by driving or squeezing numerous carbon particles into the surface thereof. Two methods can be employed in accordance with the invention. In a first method, a mixture of valve metal powder and carbon powder is heated near its melting point and pressurized in a container to make an ingot so that the carbon powder may be contained in the valve metal ingot. A second method includes a carbon-powder driving step wherein carbon particles are driven into the surface of a valve metal material by pressurizing carbon particles dispersed on the surface of the valve metal material. Pressing using dies or rollers may be employed to drive powder of carbon particles into a valve metal sheet, then, carbon particles being fixed in the surface of the valve metal sheet with the particle exposed on the surface. Prior to pressing the valve metal material may preferably be roughened or electrochemically etched on the surface, particularly be made porous in a thin layer of the surface, facilitating carbon particles to engage and embed in the porous surface layer effectively. In either of the two methods, carbon particles can be pressed and fitted in the surface of the valve metal material and fixed. This invention was used by the authors to reduce the contact resistance between metal current collectors and electrodes in both lithium ion secondary batteries and EDLC. The batteries exhibited excellent high-rate performance, and the resistance of EDLC electrodes was reduced by 2-3-fold.

U.S. Pat. Nos. 6,627,252, 6,643,119 and 6,804,108 (Nanjundiah, et al.), and U.S. Pat. No. 6,631,074 (Bendale, et al.) disclose an EDLC having low-resistance carbon powder electrodes. Their method includes the steps of: preparing a first slurry that includes conducting carbon powder and a binder; applying the first slurry to the bare aluminum surface of the foil (a current collector plate); drying the applied first slurry to form a primary coating; preparing a second slurry that includes nano-porous carbon powder, a solvent and a binder; and applying the second slurry to the primary coating. The primary coating preferably comprises a highly conducting carbon powder (e.g., graphite) in large proportion and a polymer binder. Prior to the coating process, the surface of the aluminum foil can be corona treated, or mechanically or chemically modified to promote wettability and adhesion. Other possible methods of making the carbon electrodes include employing perforated foil collector plates or screens. The primary coating is then applied using a slurry transfer apparatus such as a reverse comma coat system and other methods such as slot coating. Gravure, extrusion, flexographic or roll coating methods may also be used. The thickness of the resulting primary coating is about 4 to 6 pm. The primary coating reduces the interfacial resistance and serves as a seed coat for a secondary coating with a layer of nano-porous carbon material that serves as a double layer electrode. An EDLC made in accordance with the above-described method had a capacitance of about 2,650 to 2,700 F and an impedance of less than 0.6 mOhm. This corresponds to an RC-constant value of ca. 1.6 s, though the authors targeted to the value as low as 0.5 s.

U.S. Pat. No. 6,831,826 to Iwaida, et al. discloses a method for reducing the contact resistance between the sheet-shaped carbon electrodes and aluminum foil (current collector) by attaching the electrodes to the foil surface through a conductive adhesive. In accordance with the invention, the laminating step is performed by attaching the sheet-shaped electrodes while applying the conductive adhesive with a thickness of 10 micron or less to the surface of the conductive foil by using a gravure coater. It is preferred that the adhered portions of the foil surface are made rough in advance by an etching treatment or the like.

U.S. Pat. Nos. 6,602,742 and 6,697,249 to Maletin, et al. disclose a method to reduce the contact resistance in EDLC devices due to covering the carbonaceous electrode with a thin aluminum layer using the plasma activated physical vapor deposition of aluminum in high vacuum followed by welding this layer to the aluminum current collector. Such a technology provides very low contact resistance (see Table 1 below) resulting in very low RC-constant values (about 0.3 s); however, this is a labor-intensive and expensive technology.

### DESCRIPTION OF THE FIGURES

A fuller understanding of the present invention and the features and benefits thereof will be accomplished upon review of the following detailed description together with the accompanying drawings, in which:

FIG. 1 is a schematic drawing of electric-spark method to fuse the carbon particles into a metal foil: 101 is an electric-spark generator 102 is a carbon rod; 103 is the metal foil current collector.

FIG. 2 a, b shows a cross-sectional view of a metal foil (current collector) doped with carbon particles, which are or embedded into the metal surface: a) illustrates one-side embedding; b) illustrates two-sided embedding.

FIG. 3 shows a cross-sectional view of a one-side gradient electrode fabricated in accordance with a method presented in this invention: 301 is the metal current collector; 302 is a layer of graphite particles fused or embedded into the metal surface; 303 is a nano-porous carbon electrode comprising an activated carbon powder and a binder.

FIG. 4 illustrates a magnified view (observed with microscope) of the metal surface with carbon particles fused thereon.

FIG. 5 illustrates a method for measuring the resistivity of electrodes wherein a constant current passes across the aluminum current collector, the electrode and platinum foil are pressed on top, and the voltage drop between two foils is measured by a high-input impedance voltmeter.

### DETAILED DESCRIPTION OF THE PREFERRED EMBODIMENTS

To achieve the objectives of the present invention the general method for fabricating an electrode can be described as follows:
The method of electrode fabrication includes fabrication of the metallic current collector and polarization electrode. The surface of the metallic foil is preliminary treated chemically or mechanically with the goal of increasing the surface area or providing a rough surface.
In the next step, on the surface of the metallic current collector an initial layer of carbon materials is disposed (FIG. 4). For this purpose, highly conductive carbon particles, e.g. graphite particles, are fused or embedded into the metal foil (current collector) using an electric spark or electric arc deposition, a carbon rod being used as one of two electrodes and the foil as the other electrode.

A second layer of carbon material with high conductivity is coated onto the first layer of carbon material, which has been fused into the metal foil.

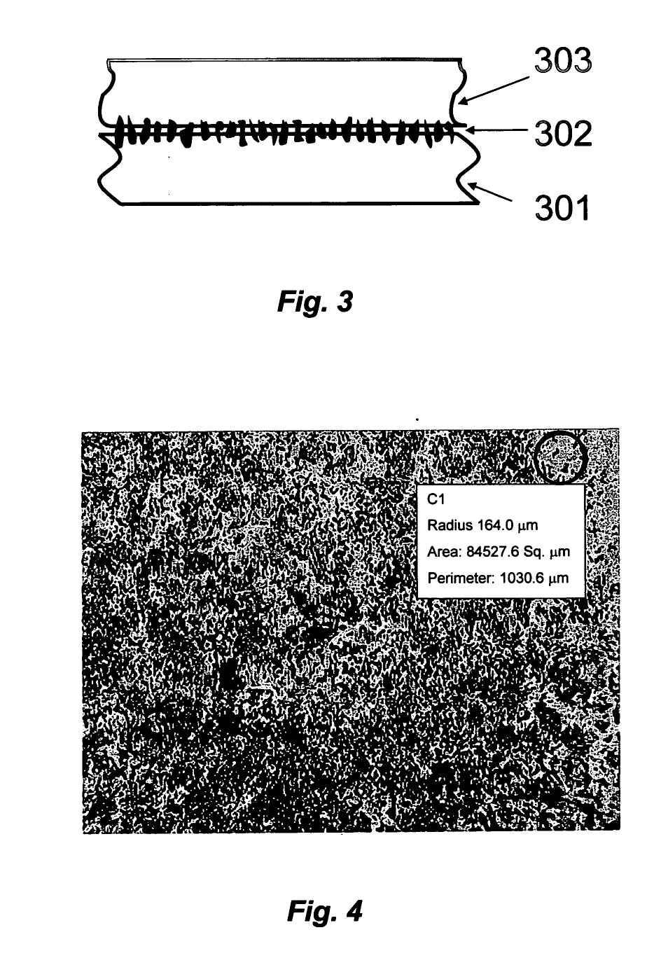

In the next step, a polarizing electrode is rolled, or pressed, or cast (FIG. 3), or spread on the current collector coated with carbon material made in the previous steps. The polarizing electrode is fabricated, for example, from nano-porous carbon powder and a binder (as in EDLC technology), or from metal oxide/sulphide powder, a conductive additive such as a graphite powder, and a binder (as in lithium battery technology).

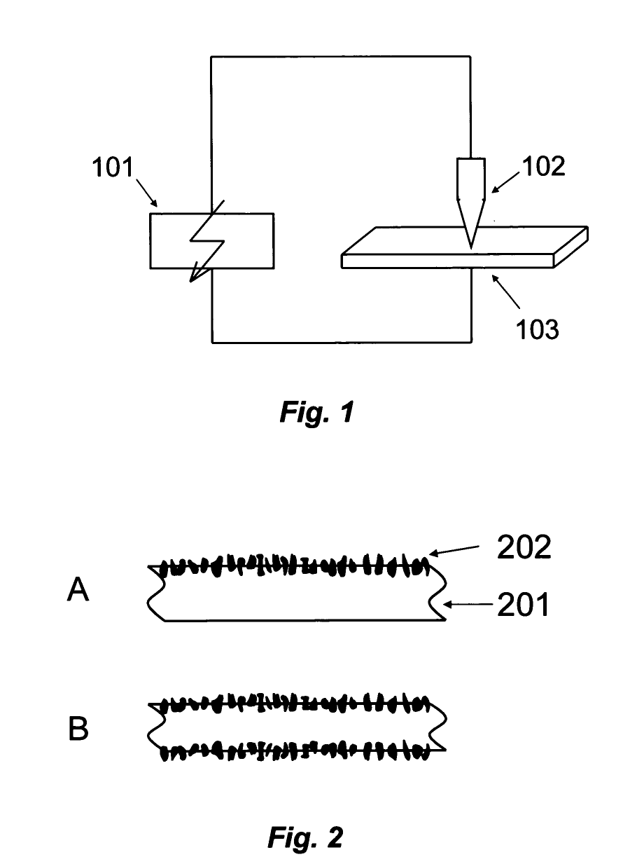

In an electric-spark technique, preferably be employed in this embodiment, a short-term electric spark between a carbon rod and aluminum foil is formed by moving the carbon rod back and forth near the surface of the foil (FIG. 1). Upon close approach, an electrical spark or arc is initiated between the carbon rod and the aluminum surface.

The spark melts the aluminum metal locally, and carbon particles detach from the rod and fuse into the metal surface (FIG. 2). Either the carbon rod or metal foil can move horizontally so that the electric-spark machine acts as a “sewing machine” forming a stitch of carbon particles fused into metal surface (FIG. 4).

The diameter of carbon particles fused into the metal current collector surface should preferably be in the range of 0.01 to 50 microns, more preferably, in the range of 0.1 to 10 microns. It is also preferable that carbon particles project from the surface of metal foil to increase the contact area between this first layer of conductive carbon particles and the second layer of carbon-containing electrode. To further increase the contact area and to improve “the anchoring affect” the metal foil can be roughened either mechanically or chemically. This can be accomplished, for example, by rolling the metal foil with emery paper or by etching the foil chemically or electrochemically, or by any other common method that increases the surface area of the metal foil.

As another embodiment of this invention, an interlayer of highly conductive carbon powder, such as graphite powder or acetylene black, can be applied on the first layer of carbon particles fused into the metal current collector followed by pressing, rolling or spreading the second layer of polarizing electrode onto the surface thus formed. Due to this embodiment the electrical contact between the first layer, which is fused into the metal current collector, and the second layer, which is the polarizing electrode of the battery or EDLC, can further be improved.

The present invention is described in more detail below by examples. It should be understood, however, that the present invention is not limited to these examples but can as well be embodied in other forms and devices without departing from the scope and spirit of the invention.

### Example 1

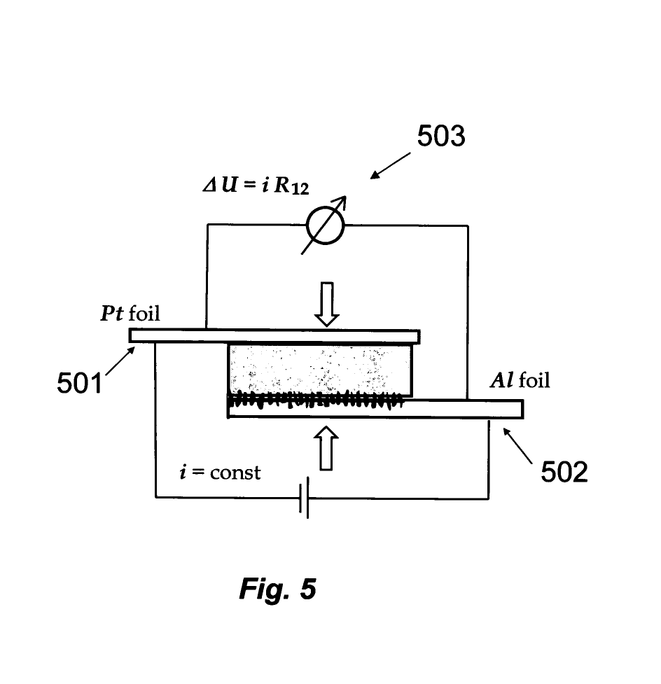

Aluminum foil with the thickness 20 microns was pressed with a copper plate with the frame from stainless steel with a rectangular window 35×45 mm. With the help of an electro spark device, which included a positive electrode from graphite rod and negative electrode of aluminum foil, the aluminum foil was doped with the particles of graphite over the windows of the frame. The current of the process was 0.6 A. The duration was 6 minutes. As a result, a layer of graphite was fused into the surface of the aluminum. The thickness of this graphite layer was 3-5 microns. Onto the aluminum current collector with the graphite layer that was fused into the surface of the aluminum, a suspension of nano-porous carbon powder with PVDF binder was coated. The concentration of the binder was 10%. The method of coating was casting. After drying, and following forge-rolling, the thickness of the nano-porous carbon was approximately 100 microns. The resistance of electrode that was fabricated by the method described above was measured. The method of the resistance measurement used is described below. A scheme of this method is shown in FIG. 5. Results of the measurements are presented in Table 1, line 1.

### Example 2

Aluminum foil having a thickness of 60 microns was passed through rolls several times with emery paper to roughen the surface. Thereafter, the aluminum foil was pressed with a copper plate with the frame of stainless steel, with a rectangular window 35×45 mm. Using an electro-spark device that included a positive electrode comprising a graphite rod and a negative electrode that comprised said aluminum foil, the roughened aluminum foil was doped with particles of graphite over the windows of the frame. The electrical current of the doping process was between 0.6 A and 1.0 A. The duration of the process was 7 minutes. The resulting layer of the graphite was fused into the surface of the aluminum. The thickness of this graphite layer was 3-5 microns.

A suspension of nano-porous carbon powder with PTFE binder was disposed onto the aluminum current collector with the graphite layer that was fused into the surface of the aluminum. The concentration of the binder was 7%. The method of coating was casting. After drying, and following forge-rolling, the thickness of the nano-porous carbon layer was approximately 100 microns. The resistance of electrode that was fabricated by the method described above was measured. The method of the resistance measurement is described below. A scheme depicting the method is presented in FIG. 5. Results of the measurement are presented in the Table 1, line 2.

### Example 3

The surface of an aluminum foil strip with thickness 60 micron was treated as described in Example 2. Thereafter, the aluminum foil was pressed with a copper plate and the surface of the aluminum foil was doped as described in Examples 1 and 2. The current of the doping process was between 0.6 A and 1.0 A. The duration of the process was 8 minutes. The thickness of the resulting graphite layer that was fused into the surface of the aluminum was 3-5 micron. Thereafter, a thin layer (1-2 micron) of acetylene black was disposed onto the surface. Thereafter, onto the fabricated surface that included aluminum and two layers of carbon, a suspension of nano-porous carbon powder with PTFE binder (7%) was coated using the method of forge-rolling. The resulting thickness of the nano-porous carbon was approximately 100 microns. The resistance of the electrode that was fabricated by the method describe above was measured. The method used for the resistance measurement is described below. A scheme of the method is shown in FIG. 5. Results of the measurement are presented in Table 1, line 3.

The electrical resistances of nano-porous carbon electrodes made in accordance with the present invention (Examples 1-3) were measured by determining the voltage drop across the electrode using a 4-connection circuit as presented in FIG. 5. A platinum foil pressed to the upper surface of the electrode as in FIG. 5 was used as an electrical contact when a constant current was passed through the electrode. The contributions to the total electrode resistance from different components, namely; from the contact resistance between the collector foil and carbon electrode, R_{Al/C}, from the carbon electrode itself, Rc, and from the contact resistance between the carbon electrode and platinum foil, R_{Pt/C}, were eliminated by measuring the total resistance at various electrode thickness and replacing the aluminum collector foil with another platinum foil. The results of measurements are listed in Table 1, below, wherein some known methods of electrode fabrication are also presented for comparison purposes.

The results presented in Table 1 below show that the plain Al foil leads, as can be anticipated, provides to very high contact resistance (ca. 2 Ohm.cm²). If the contact area is increased due to using a grid or roughened metal collector surface, the contact resistance reduces to ca. 0.6 Ohm.cm² but it is still rather high for EDLC application. This is supposedly due to the existence of a native insulating oxide film on the aluminum surface.

It is possible to reduce the contact resistance if use the vacuum deposition of the Al in the surface of carbon polarization electrode and follow the welding the Al which was deposited to the aluminum foil current collector. However this method is very expensive and labor-intensive.

TABLE 1
Resistivity of carbon electrodes fabricated by different methods

| | | Contribution to the total |
|---|---|---|
| Nanoporous carbon electrode | Total resistivity, | resistivity from Al/C contact |
| system | Ohm · cm² | resistance, Ohm · cm² |
| C-electrode with PVDF rolled onto | 0.13 (10.02) | 0.06 (10.02) |
| doped Al foil (Example 1) | | |
| C-electrode with PTFE rolled onto | 0.09 (10.01) | 0.03 (10.01) |
| roughened and doped Al foil | | |
| (Example 2) | | |
| C-electrode with PTFE rolled onto | 0.07 (10.01) | less then 0.01 |
| Al foil which was roughened and | | |
| doped and was coated with the | | |
| intermediate layer of the graphite | | |
| (Example 3) | | |
| C-electrode which is connected | | 1.22 |
| with the | | |
| current collector via the layer of | | |
| solid granular carbon (prototype) | | |
| C-electrode with PTFE coated on | 1.1-2.1 | 1-2 |
| the smooth Al foil | | |
| (analog) | | |
| C-electrode with PTFE coated on | 0.7 (10.2) | 0.6 |
| the Al foil which was roughened | | |
| (analog) | | |
| C-electrode with PTFE, coated | 0.09 (10.01) | 0.03 |
| with Al in vacuum and welded with | | |
| Al current collector (analog) | | |

If the electrodes are made using the method of the present invention, the resistivity can be lowered as compared with the method of vacuum deposition of the aluminum, and can reach 0.03 Ohm.cm². The simplicity and cost efficiency of the present invention are evident, and the resulting reduced cost and labor required in the fabrication of supercapacitors are a substantial advantage of the present invention.

It is to be understood that while the invention has been described in conjunction with the preferred specific embodiments thereof, that the foregoing description, as well as the examples which follow, are intended to illustrate and not limit the scope of the invention. Other aspects, advantages and modifications within the scope of the invention will be apparent to those skilled in the art to which the invention pertains.

We claim:

1. A method of fabricating low contact resistance electrodes for batteries and double-electric layer capacitors, comprising the steps of:
providing a current collector and a polarization electrode;
introducing a plurality of highly electrically conductive carbon particles into a surface of said current collector to form a first carbon comprising layer, and
joining said electrode to said surface of said current collector.

2. The method of claim 1, wherein said current collector comprises a metal foil.

3. The method of claim 2, wherein a plurality of highly electrically conductive carbon particles is fused into said metal foil.

4. The method of claim 3, wherein an electrical spark or an electrical arc is used for said fusing.

5. The method of claim 1, wherein said electrode is a carbon comprising electrode.

6. The method of claim 2, further comprising the step of roughening the surface of said metal foil by a mechanical or chemical method before said joining.

7. The method of claim 1, wherein said carbon particles have an average diameter within the range 0.01-50 microns.

8. The method of claim 1, wherein said polarization electrode comprises a carbon-comprising material and a binder.

9. The method of claim 1, wherein said polarization electrode is produced from nanoporous carbon-comprising powder with a binder applied on said first carbon comprising layer by rolling, pressing or slip casting.

10. The method of claim 1 wherein said polarization electrode comprises a metal oxide or sulfide mixed with an electrically conducting additive and a binder.

11. A battery or double-electric layer capacitor, comprising:
a first and second current collector having first and second electrodes coupled thereto, wherein at least one of said current collectors includes a plurality of highly electrically conductive carbon particles in a surface said current collector.

12. The method of claim 1, wherein at least one of said electrodes are carbon comprising electrodes.
